(19) United States
(12) Patent Application Publication
(10) Pub. No.: US 2002/0147905 A1
(43) Pub. Date: Oct. 10, 2002

(54) System and method for shortening certificate chains

(75) Inventor: Radia J. Perlman, Acton, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: Sun Microsystems, Inc.

(21) Appl. No.: 09/826,592

(22) Filed: Apr. 5, 2001

(51) Int. Cl. H04L 9/00

(52) U.S. Cl. 713/157

(57) ABSTRACT

A system and method for shortening a certificate chain to form a collapsed certificate. The certificate chain comprises a plurality of linked certificates issued by a corresponding plurality of entities. The certificate chain extends from a first entity, through at least one intermediate entity, to a target entity associated with certain predetermined information. The plurality of linked certificates in the certificate chain is converted by the first entity into a collapsed certificate that is signed by the first entity and includes the predetermined information and an identification of the at least one intermediate entity. By utilizing the collapsed certificate in place of the plurality of linked certificates in the certificate chain, bandwidth utilization within a network and certificate processing overhead are reduced.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

The present invention relates generally to security mechanisms, and more specifically to a system and method for shortening a certificate chain.

The use of Certification Authorities (CA's) in computer networks for the generation and issuance of certificates is well known in the art. A CA typically comprises a computer that issues and signs certificates, which may be relied upon by other entities in the network (e.g., other computers such as clients or servers) that trust the CA. Entities in a computer network frequently employ public/private key pairs for purposes such as encryption, integrity checking, or authentication of messages exchanged via the network.

For example, a CA may issue and sign an identity certificate that includes indications of a name of an entity and a public key associated with that entity. A CA may also issue and sign a group membership certificate that includes indications of names of members of a particular group and a public key associated with that group. Other types of certificates are also known.

Various models of Public Key Infrastructures (PKI's) have been deployed in computer networks to enable the discovery of public keys. One such PKI model is known as the “top-down” hierarchical model comprising a single root CA. The root CA is typically configured into and trusted by all of the entities in the network. Further, the root CA can sign certificates authorizing intermediate CA's in the network to grant certificates, and these intermediate CA's can sign certificates giving other CA's in the network such certificate granting authority.

For example, by way of the top-down model, a first entity may discover the public key of a second entity in the network by obtaining a chain of linked certificates extending from the root CA, through any intermediate CA's in the hierarchy, to the second entity. Because the first entity trusts the root CA, and the CA's in the chain trust the respective intermediate CA's to which they have extended certificate granting authority, the chain of linked certificates provides the first entity with a verified path through the PKI model to the public key of the second entity.

Although CA's and PKI's have been successfully used in computer networks to enable secure and reliable generation and issuance of certificates, one drawback is that the chains of certificates generated thereby can often be long and require significant bandwidth to transmit to various entities over the computer network. Such long certificate chains may also inordinately increase the computation overhead of entities that need to verify the identities of other entities in the network.

It would therefore be desirable to have a mechanism for reducing the computation overhead required to confirm a chain of certificates, and for reducing the bandwidth required to transmit the certificate chain over a network.

### BRIEF SUMMARY OF THE INVENTION

Consistent with the present invention, a system and method is provided for shortening a certificate chain. Such a certificate chain comprises a plurality of linked certificates issued by a corresponding plurality of entities. The certificate chain extends from a first entity, through at least one intermediate entity, to a target entity associated with certain predetermined information, e.g., the target entity's public key in a Public Key Infrastructure (PKI) system or any other desired information. The plurality of linked certificates in the certificate chain is converted by the first entity into a collapsed certificate that includes the predetermined information associated with the target entity, and an identification of at least one intermediate entity. In one embodiment, the collapsed certificate is signed by the first entity and includes an identification of each intermediate entity. By utilizing the collapsed certificate in place of the plurality of linked certificates in the certificate chain, advantages in the form of reduced bandwidth utilization within a network and reduced certificate processing overhead are achieved.

Before granting access to a resource or performing a prescribed service, the identifications of the intermediate entities contained in the collapsed certificate may be tested against a Certificate Revocation List (CRL) to ensure that none of the intermediate entities are deemed untrustworthy. In the event it is determined that any of the intermediate entities identified in the collapsed certificate are identified on the CRL as being untrustworthy, access to the resource or prescribed service may be denied.

Other features, aspects and advantages of the presently disclosed system and method will be apparent from the detailed description that follows.

### BRIEF DESCRIPTION OF THE SEVERAL VIEWS OF THE DRAWING

The invention will be more fully understood by reference to the detailed description in conjunction with the drawings, of which:

FIG. 1 is a block diagram depicting a computer system operative in a manner consistent with the present invention;

FIG. 2 is a block diagram of an exemplary computer that may be employed to perform the functions of the entities depicted in FIG. 1;

FIG. 3 is a block diagram of a public key infrastructure model deployed in the computer system of FIG. 1;

FIG. 4 is a diagram representing a conventional certificate chain;

FIG. 5 is a diagram representing a collapsed certificate consistent with the present invention; and

FIG. 6 is a flow diagram depicting a method of operation of the computer system of FIG. 1 for shortening a certificate chain in a manner consistent with the present invention.

### DETAILED DESCRIPTION

A system and method are disclosed for shortening a chain of linked certificates to form a collapsed certificate. The chain of linked certificates extends from a first entity, through at least one intermediate entity, to a target entity associated with certain predetermined information. For example, the predetermined information associated with the target entity may comprise the target entity's public key in a Public Key Infrastructure (PKI) system or any other desired information. By way of the collapsed certificate, the first entity vouches for the predetermined information associated with the target entity.

The collapsed certificate includes at least the predetermined information associated with the target entity, and an identification of at least one intermediate entity. In one embodiment, the collapsed certificate is signed by the first entity, and includes an identification of each intermediate entity. Use of the collapsed certificate in place of the plurality of certificates in the certificate chain for verifying the predetermined information associated with the target entity can reduce bandwidth utilization and processing overhead typically associated with the processing of linked certificates, as discussed in greater detail below.

The identification(s) of the intermediate entities in the collapsed certificate may be tested against a Certificate Revocation List (CRL) to determine whether any of the intermediate entities are deemed untrustworthy. In the event any of the intermediate entities are deemed untrustworthy as a result of the test against the CRL, a determination may then be made not to honor the collapsed certificate.

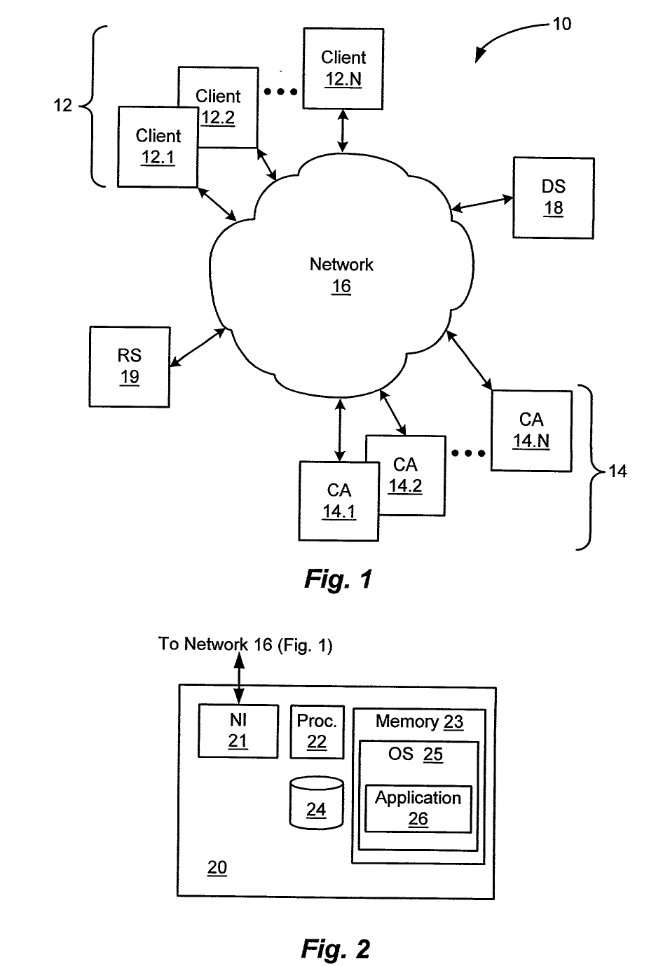

FIG. 1 depicts an illustrative embodiment of a system 10 for shortening a certificate chain consistent with the present invention. The system 10 includes a plurality of entities. In this illustrative embodiment, such entities may comprise components in a computer network such as principals, clients, servers, and software processes running on network nodes.

Specifically, the system 10 includes a plurality of clients 12.1-12.N, a plurality of Certification Authorities (CA's) 14.1-14.N, a Directory Server (DS) 18 operative to provide access to certificates issued by one or more of the CA's 14, and a Revocation Server (RS) 19 operative to maintain one or more Certificate Revocation Lists (CRL's). The clients 12, the CA's 14, the DS 18, and the RS 19 are communicably coupled to one another by way of a computer network 16 to allow communication of information and/or messages between the respective devices. For example, the computer network 16 may comprise a Local Area Network (LAN), a Wide Area Network (WAN), a global computer network such as the Internet, or any other network for communicably coupling the devices to one another.

Each of the clients 12, the CA's 14, the DS 18, and the RS 19 comprises a computer system 20, as generally depicted in FIG. 2. The computer system 20 may be in the form of a personal computer or workstation, a personal digital assistant (PDA), an intelligent networked appliance, a controller or any other device capable of performing the functions attributable to the respective devices, as described herein.

As shown in FIG. 2, the computer system 20 includes a processor 22 operative to execute programmed instructions out of a memory 23. The instructions executed in performing the functions herein described may comprise instructions stored as program code considered part of an operating system 25, instructions stored as program code considered part of an application 26, or instructions stored as program code allocated between the operating system 25 and the application 26. The memory 23 may comprise Random Access Memory (RAM), or a combination of RAM and Read Only Memory (ROM). Each device within the system 10 includes a network interface 21 for coupling the respective device to the computer network 16. The devices within the system 10 may optionally include a secondary storage device 24.

In this illustrative embodiment, the clients 12 and the CA's 14 employ public/private key pairs. For example, the CA's 14 may issue and sign certificates such as an identity certificate that includes indications of a name of a client and a public key associated with that client. It is noted that the clients 12 in the computer network 16 may utilize such identity certificates when requesting access to resources and/or services available by way of the network 16.

Specifically, if a first client trusts a CA, then the first client can discover the public key of a second client by obtaining an identity certificate of the second client issued and signed by the CA. Further, using the public key of the CA, the first client can verify the second client's identity certificate. For example, if there are two (2) clients communicably coupled to one another by way of the computer network 16, and each client knows its respective private key and can discover the other client's public key, then the two (2) clients may communicate securely with one another over the network 16 using a suitable public key based protocol.

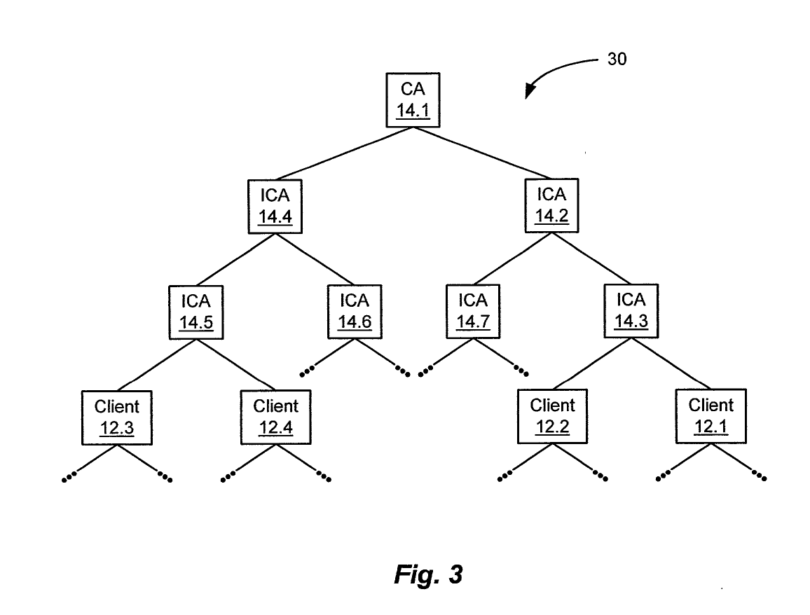

FIG. 3 depicts an exemplary Public Key Infrastructure (PKI) model 30, which may be deployed in the computer network 16 (see FIG. 1) to enable the discovery of public keys. Specifically, the PKI model 30 comprises a “top-down” hierarchical model that includes a single root CA 14.1, a plurality of Intermediate Certification Authorities (ICA's) 14.2-14.7, and a plurality of clients 12.1-12.4. In an alternative embodiment, at least one of the ICA's 14.2-14.7 may comprise a Registration Authority (RA), from which a CA may obtain information needed to grant certificates.

In the top-down model 30, each of the clients 12.1-12.4 trusts the root CA 14.1. Further, the public key of the root CA 14.1 is configured into each of the clients 12.1-12.4. Accordingly, each client 12.1-12.4 trusts the CA 14.1 and knows the public key of the root CA 14.1.

The manner in which the system 10 can be employed to shorten a chain of linked certificates will be better understood with reference to the following illustrative example. In this illustrative example, the client 12.1 employs the above-described top-down model 30 (see FIG. 3) to discover a public key of the client 12.3. It is understood that the client 12.1 knows its own private key and the public key of the root CA 14.1.

In this example, the client 12.1 issues a request directly to the root CA 14.1 for a certificate comprising the public key of the client 12.3. In response to this request, the CA 14.1 accesses (i.e., obtains or generates) a chain of linked certificates extending from the CA 14.1, through the ICA's 14.4 and 14.5, to the client 12.3. In one embodiment, the CA 14.1 retrieves the certificate chain from the DS 18 by sending requests therefor to the DS 18, and receiving the requested certificate chain from the DS 18 by way of the network 16. In another embodiment, a system administrator (not shown) issues a request for the certificate chain to at least one of the CA's 14.1-14.7, and provides the requested certificate chain to the CA 14.1.

Next, the CA 14.1 makes a determination as to whether the certificate of the client 12.3 should be issued to the client 12.1. Such a determination may comprise an analysis of credentials accompanying the request, a verification of the authenticity of the request using, e.g., a digital signature of the client 12.1, or any other suitable basis for determining whether the certificate should be issued to the client 12.1.

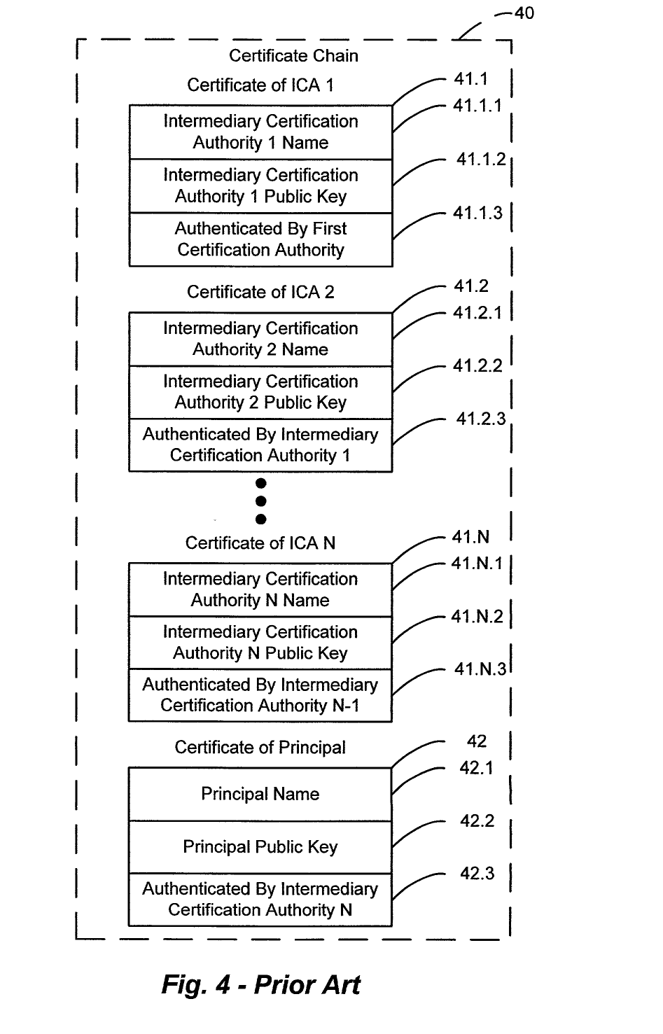

FIG. 4 depicts a conceptual representation of a conventional certificate chain 40, which may be issued by a CA in response to a request by a client. The certificate chain 40 includes a plurality of linked certificates 41.1-41.N and 42. Each of the certificates 41.1-41.N includes indications of an ICA name, a public key associated with that ICA, and an authentication portion that may comprise a digital signature of a CA or ICA issuing the certificate or any other suitable form of authentication. Similarly, the certificate 42 includes indications of a client name, a public key associated with that client, and an authentication portion that may comprise a digital signature of a CA or ICA issuing the certificate.

Specifically, as shown in FIG. 4, the certificate 41.1 includes an ICA_1 name 41.1.1, an ICA_1 public key 41.1.2, and an authentication portion 41.1.3 digitally signed by the CA; the certificate 41.2 includes an ICA_2 name 41.2.1, an ICA_2 public key 41.2.2, and an authentication portion 41.2.3 digitally signed by the ICA_1; and, the certificate 41.N includes an ICA_N name 41.N.1, an ICA_N public key 41.N.2, and an authentication portion 41.N.3 digitally signed by the ICA_(N-1). Further, the certificate 42 includes a client name 42.1, a client public key 42.2, and an authentication portion 42.3 digitally signed by the ICA_N.

Certificate chains generated by CA's in conventional systems typically comprise certificate chains like the certificate chain 40. For example, in the event the top-down model 30 is deployed in a conventional system, the CA 14.1 may generate for the client 12.3 a conventional certificate chain comprising a first certificate including a public key of the ICA 14.4 digitally signed by the CA 14.1, a second certificate including a public key of the ICA 14.5 digitally signed by the ICA 14.4, and a third certificate including the public key of the client 12.3 digitally signed by the ICA 14.5. The root CA 14.1 may then provide the generated certificate chain comprising the three (3) linked certificates to the requesting client 12.1.

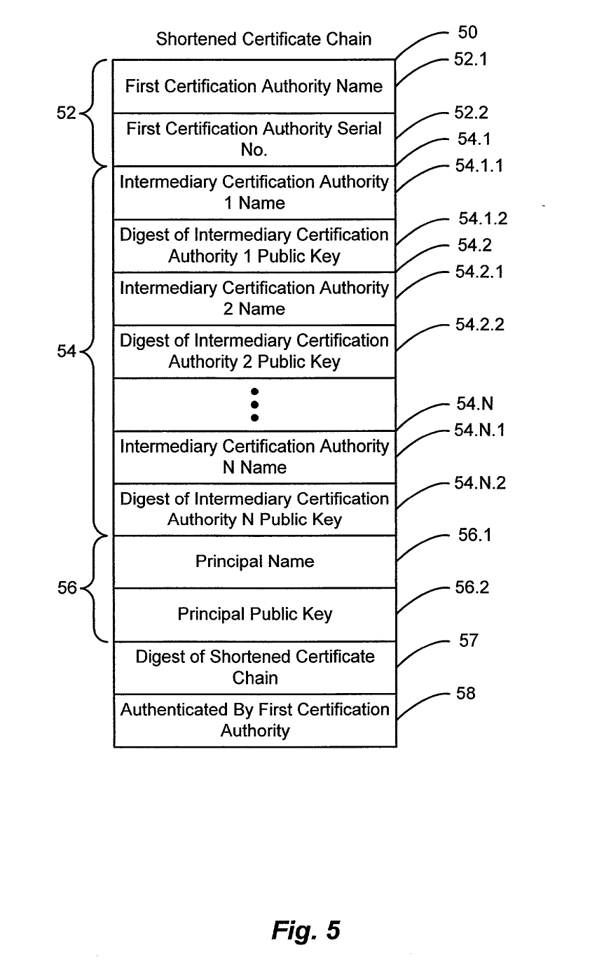

Consistent with the present invention, a conventional certificate chain comprising a plurality of linked certificates is converted into a collapsed certificate. FIG. 5 depicts a conceptual representation of an exemplary collapsed certificate 50 issued by a CA in response to a request by a client. In one embodiment, the collapsed certificate 50 includes an indication 52 of the identity of a CA, an indication 54 of the identity of at least one ICA (i.e., the ICA's 54.1-54.N), and an indication 56 of the identity of a client.

Specifically, the collapsed certificate 50 includes a CA name 52.1, a digest 52.2 of a public key of the CA 52, respective names 54.1.1-54.N.1 of ICA's 54.1-54.N, and respective digests 54.1.2-54.N.2 of public keys of the ICA's 54.1-54.N. It is noted that the digest 52.2 may be used to verify the CA 52, and the digests 54.1.2-54.N.2 may be used to verify the ICA's 54.1-54.N. The digests 52.2 and 54.1.2-54.N.2 may be generated by applying the respective public keys of the CA 52 and the ICA's 54.1-54.N to a predetermined hash function.

Further, the indication 56 of the identity of a client comprises an indication of a client name 56.1 and a public key 56.2 associated with that client. Moreover, the collapsed certificate 50 includes an authentication portion 58 that may comprise a digital signature of the CA or ICA issuing the collapsed certificate 50 or any other suitable form of authentication.

In one embodiment, the collapsed certificate 50 further includes a digest 57 of the collapsed certificate 50, which may be used to verify the certificate 50. Like the digests 54.1.2-54.N.2, the digest 57 may be generated by applying the collapsed certificate 50 to a predetermined hash function.

In this illustrative example, the client 12.1 obtains a verified path through the top-down model 30 (see FIG. 3) to the public key of the client 12.3 by receiving a collapsed certificate conforming to the exemplary collapsed certificate 50 (see FIG. 5) from the root CA 14.1. In alternative embodiments, the client 12.1 receives such a collapsed certificate from the ICA 14.2 or the ICA 14.3. It is noted that the root CA 14.1 and/or the ICA's 14.2-14.7 may explore paths through the PKI, and issue collapsed certificates upon their own volition.

For example, in response to a request from the client 12.1 for a certificate certifying the public key of the client 12.3, the CA 14.1 may generate or obtain a chain of linked certificates extending from the root CA 14.1, through the ICA's 14.4 and 14.5, to the client 12.3. The CA 14.1 then generates a collapsed certificate using the plurality of linked certificates. In one embodiment, the collapsed certificate includes a name of the root CA 14.1, a digest of a public key of the root CA 14.1, a name of the ICA 14.4, a digest of a public key of the ICA 14.4, a name of the ICA 14.5, a digest of a public key of the ICA 14.5, a name of the client 12.3, a public key of the client 12.3, a digest of the collapsed certificate, and an authentication portion digitally signed by the root CA 14.1.

Accordingly, the clients 12 (see FIG. 1) may discover each other's public key by obtaining a collapsed certificate, as described above, instead of obtaining a conventional certificate chain comprising a plurality of linked certificates. Obtaining and distributing such collapsed certificates over the computer network 16 typically requires less bandwidth than obtaining and distributing comparatively long certificate chains over the network. Further, verifying such collapsed certificates on the computer network 16 typically requires less computation overhead than verifying conventional certificate chains. This is because in shortening a certificate chain, the CA signing the collapsed certificate, in effect, vouches for the certificates granted by the respective intermediate entities in the chain. As a result, a client or other entity in the network need not expend extra processing time confirming the certificates that have already been vouched for by the signing CA.

Moreover, CA's or clients may determine whether the certificate of any ICA in the chain has been revoked by testing the names of the ICA's included in the collapsed certificate against names included in a CRL maintained by the RS 19.

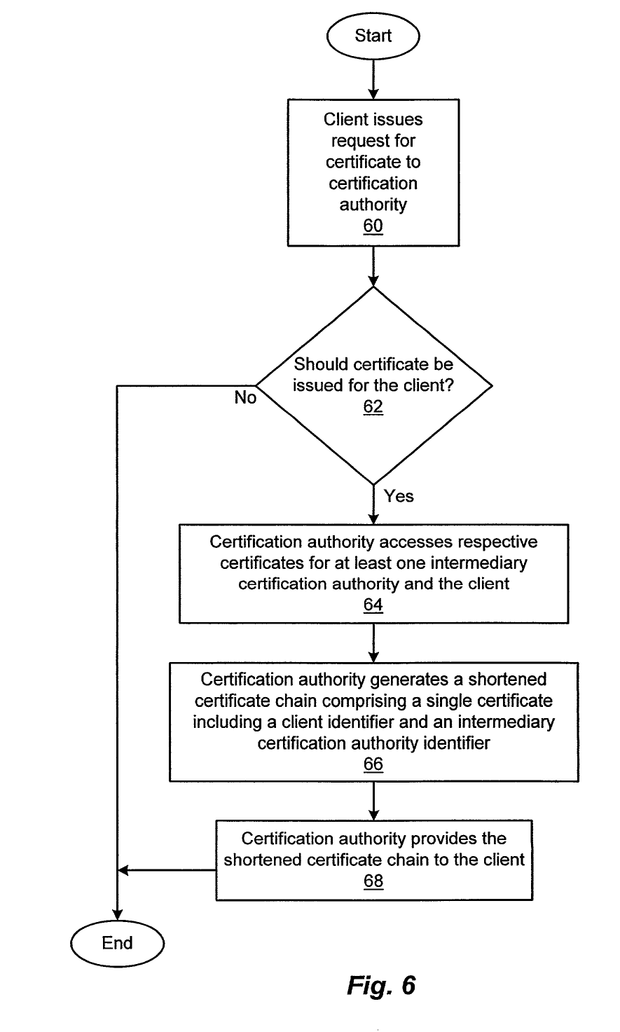

A method of operation of the system 10 (see FIG. 1) is illustrated by reference to FIG. 6. In this exemplary method of operation, it is understood that a suitable PKI model is deployed in the computer network to enable the discovery of public keys.

As depicted in step 60, a first client issues a request for a certificate of a second client to a CA such as a root CA. It is understood that there is at least one intermediate entity in the path through the PKI model between the root CA and the second client. In response to the request, the root CA makes a determination, as depicted in step 62, as to whether a certificate of the second client should be issued to the first client. In the event it is determined that a certificate should not be issued to the first client, the method terminates. In the event it is determined that a certificate should be issued to the first client, the root CA accesses (i.e., generates or obtains), as depicted in step 64, respective linked certificates for the at least one intermediate entity and the second client. The root CA then generates, as depicted in step 66, a collapsed certificate comprising indications of identifiers for the root CA, the intermediate entity, and the second client; predetermined information associated with the second client; and, an authentication portion digitally signed by the root CA.

In one embodiment, the indication of the root CA identifier includes a name of the root CA and a digest of a root CA public key, the indication of the intermediate entity identifier includes a name of the intermediate entity and a digest of an intermediate entity public key, the indication of the second client identifier includes a name of the second client, and the predetermined information associated with the second client includes the second client's public key. Next, the root CA provides, as depicted in step 68, the collapsed certificate directly to the requesting first client.

As a result, instead of issuing a certificate chain comprising a plurality of linked certificates to the first client, the root CA issues the collapsed certificate comprising at least the certificate signed by the root CA, and the indication of the intermediate entity identifier.

It should be understood that the above-described indications of the root CA, the intermediate entity, and the client identifiers are merely presented by way of illustration, and may therefore take different forms. For example, it was described above that a collapsed certificate may comprise an identity certificate including indications of a client name and a client public key, and an authentication portion digitally signed by a trusted certification authority. However, it is understood that any desired type of certificate may be included in the collapsed certificate in place of the identity certificate.

Moreover, it was described above in the illustrative example that the root CA 14.1 may access respective linked certificates for the ICA's 14.4 and 14.5 and the client 12.3, and generate a collapsed certificate for the client 12.3 signed by the root CA 14.1 and including indications of the identities of the ICA's 14.4 and 14.5 (see FIG. 3). However, it should be understood that variations may be made to the technique employed in the illustrative example.

For example, the root CA 14.1 may generate a collapsed certificate for the ICA 14.5 signed by the root CA 14.1 and including an indication of the identity of the ICA 14.4. Similarly, the ICA 14.4 may generate a collapsed certificate for the client 12.3 signed by the ICA 14.4 and including an indication of the identity of the ICA 14.5. Accordingly, consistent with the present invention, a collapsed certificate may be generated anywhere within a chain of linked certificates, in which two (2) or more linked certificates are collapsed to form a single certificate.

Those of ordinary skill in the art should appreciate that the programs defining the functions performed by the respective devices described herein can be communicated to the respective devices in many forms including, but not limited to: (a) information permanently stored on non-writable storage media (e.g., read only memory devices within a computer such as ROM or CD-ROM disks) readable by a computer I/O attachment; (b) information alterably stored on writable storage media (e.g., floppy disks, tapes, read/write optical media and hard drives); or (c) information conveyed to a computer through a communication media, e.g., using base-band signaling or broadband signaling techniques, such as over computer or telephone networks via a modem. In addition, while the functions are illustrated as being software-driven and executable out of a memory by a processor, the presently described functions may alternatively be embodied in part or in whole using hardware components such as application specific integrated circuits, programmable logic arrays, state machines, controllers, or other hardware components or devices, or a combination of hardware components and software.

It should also be appreciated that the presently disclosed system and method for certifying information associated with an entity may be used for determining whether an entity on a computer network should be granted access to any suitable service or resource accessible over the network such as a web page, a secure area, data within a database, or privileges within the computer network.

Further, while the term certificate as used herein is intended to include traditional certificates such as identity or group certificates that include an identifier of an entity or group and an associated public key, the term certificate is also intended to encompass any signed message or data structure. By way of example and not limitation, such a certification may include, e.g., an identifier for an entity and a name of a group in which the entity is a member. The certification may also include a name of an entity, a dollar amount that the entity is authorized to sign for, or a purchase order.

Finally, it will be appreciated by those of ordinary skill in the art that modifications to and variations of the above-described system and method for shortening certificate chains may be made without departing from the inventive concepts described herein. Accordingly, the invention should not be viewed as limited except as by the scope and spirit of the appended claims.

What is claimed is:

1. A certification method, comprising the steps of:
acquiring a chain of linked certificates extending from a first entity, through at least one intermediate entity, to a second entity, the chain of linked certificates including a certificate signed by the intermediate entity vouching for predetermined information associated with the second entity; and
generating, from the chain of linked certificates, a collapsed certificate signed by the first entity vouching for the predetermined information associated with the second entity and including an identification of the at least one intermediate entity.

2. The method of claim 1 wherein the predetermined information associated with the second entity includes a public key of the second entity.

3. The method of claim 1 wherein each of the first entity and the at least one intermediate entity comprises a respective certification authority.

4. The method of claim 3 wherein the identification of the at least one intermediate entity includes indications of a name and a key associated with the respective certification authority.

5. The method of claim 4 wherein the indication of the key associated with the respective certification authority comprises a digest of the key.

6. The method of claim 3 wherein the collapsed certificate further includes an identification of the first entity.

7. The method of claim 6 wherein the identification of the first entity includes indications of a name and a key associated with the respective certification authority.

8. The method of claim 1 wherein the collapsed certificate further includes a digest of the collapsed certificate.

9. The method of claim 1 wherein the identification of the intermediate entity includes an indication of a name associated with the intermediate entity.

10. The method of claim 1 wherein the first entity signs the collapsed certificate using a digital signature.

11. The method of claim 1 further including the step of providing the collapsed certificate directly to an entity requesting the certificate.

12. A method of determining whether access to a resource at a first node in a computer network should be granted to a client at a second node in the network in response to a request for access to the resource by the client, the method comprising the steps of:
receiving the request for access to the resource at the first node from the client at the second node, the request including a collapsed certificate signed by a first certification authority vouching for predetermined information of the client and including an identification of an intermediate certification authority that vouches for the client's predetermined information;
determining whether the identification of the intermediate certification authority matches an identifier contained in a certificate revocation list; and
in the event the identification of the intermediate certification authority matches an identifier contained in the certificate revocation list, receiving an indication at the first node that a certificate for the intermediate certification authority has been revoked and denying the client access to the resource.

13. The method of claim 12 further including the step of verifying the authenticity of the request using a digital signature of the first certification authority.

14. A system for generating a collapsed certificate, the system comprising:
a memory including a computer program for acquiring a chain of linked certificates and for generating a collapsed certificate based on the respective linked certificates in the chain; and
a processor operative to execute the computer program,
the computer program including program code for:
acquiring the chain of linked certificates extending from a first entity, through at least one intermediate entity, to a second entity, the chain of linked certificates including a certificate signed by the intermediate entity vouching for predetermined information of the second entity; and
generating, from the chain of linked certificates, the collapsed certificate signed by the first entity vouching for the predetermined information of the second entity and including an identification of the at least one intermediate entity.

15. The system of claim 14 wherein each of the first entity and the at least one intermediate entity comprises a respective certification authority.

16. A system for determining whether access to a resource at a first node in a computer network should be granted to a client at a second node in the network in response to a request for access to the resource by the client, the system comprising:
a server operative to:
receive the request for access to the resource at the first node from the client at the second node, the request including a collapsed certificate signed by a first certification authority vouching for predetermined information of the client and including an identification of an intermediate certification authority that vouches for the client's predetermined information;
determine whether the identification of the intermediate certification authority matches an identifier contained in a certificate revocation list; and
in the event the identification of the intermediate certification authority matches an identifier contained in the certificate revocation list, receive an indication at the first node that a certificate for the intermediate certification authority has been revoked and deny the client access to the resource.

17. The system of claim 16 wherein the server is further operative to verify the authenticity of the request using a digital signature of the first certification authority.

18. A computer program product including a computer readable medium, the computer readable medium having a computer program stored thereon for generating a collapsed certificate, the computer program being executable by a processor and comprising:
program code operative to:
acquire a chain of linked certificates extending from a first entity, through at least one intermediate entity, to a second entity, the chain of linked certificates including a certificate signed by the intermediate entity vouching for predetermined information of the second entity; and
generate, from the chain of linked certificates, a collapsed certificate signed by the first entity vouching for the predetermined information of the second entity and including an identification of the at least one intermediate entity.

19. The computer program product of claim 18 wherein the program code is further operative to provide the collapsed certificate directly to an entity requesting the certificate.

20. A computer data signal, the computer data signal including a computer program for use in generating a collapsed certificate, the computer program comprising:
program code operative to:
acquire a chain of linked certificates extending from a first entity, through at least one intermediate entity, to a second entity, the chain of linked certificates including a certificate signed by the intermediate entity vouching for predetermined information of the second entity; and
generate, from the chain of linked certificates, a collapsed certificate signed by the first entity vouching for the predetermined information of the second entity and including an identification of the at least one intermediate entity.

21. The computer data signal of claim 20 wherein the program code is further operative to provide the collapsed certificate directly to an entity requesting the certificate.

22. An apparatus for generating a collapsed certificate, comprising:
means for acquiring a chain of linked certificates extending from a first entity, through at least one intermediate entity, to a second entity, the chain of linked certificates including a certificate signed by the intermediate entity vouching for predetermined information of the second entity; and
means for generating, from the chain of linked certificates, a collapsed certificate signed by the first entity vouching for the predetermined information of the second entity and including an identification of the at least one intermediate entity.

23. The apparatus of claim 22 further including means for providing the collapsed certificate directly to an entity requesting the certificate.
